(19) United States
(12) Patent Application Publication
(10) Pub. No.: US 2016/0015002 A1
(43) Pub. Date: Jan. 21, 2016

(54) SAFETY DOG LEASH

(71) Applicant: MOSS, LICHEN AND STONE, INC., San Rafael, CA (US)

(72) Inventors: Allison K. Huegel, San Rafael, CA (US); James S. Sergi, San Rafael, CA (US); Lee Sung Sergi, San Rafael, CA (US)

(73) Assignee: MOSS, LICHEN AND STONE, INC., San Rafael, CA (US)

(21) Appl. No.: 14/772,948

(22) PCT Filed: Mar. 11, 2014
(86) PCT No.: PCT/US14/23464

§ 371 Date: Sep. 4, 2015

Related U.S. Application Data
(60) Provisional application No. 61/779,467, filed on Mar. 13, 2013.

(51) Int. Cl. A01K 27/00

(52) U.S. Cl. CPC A01K 27/003; A01K 27/005

(57) ABSTRACT

Provided herein is a leash system, comprising: a lead; a means for attaching the proximal end of the lead to an animal; a handle at the distal end of the lead; a safety tether at the distal end of the lead; and a connector to reversibly couple the proximal and distal ends of the safety tether. Other implementations are also described and recited herein.

### CROSS-REFERENCE

This application claims priority to the U.S. provisional patent application U.S. Ser. No. 61/779,467 filed Mar.13, 2013, and entitled “Safety Dog Leash,” which is incorporated herein by reference in its entirety.

### TECHNICAL FIELD

Aspects of the present disclosure relate to animal care and safety. More specifically, the present disclosure relates to animal care systems for ensuring the safety and protection of animals, the animal handler, and the public. The present disclosure applies to companion animals, including dogs and cats, sporting and companion horses, and other large breed animals, such as cows or sheep that require a leash or lead to be secured to a fixed object.

### BACKGROUND

Existing animal leashes are inadequate for addressing the safety concerns imposed to the animal, the animal handler, and the public when the animal is leashed or tethered to a fixed object. Animal handlers rely on a variable length leash secured to the collar of the animal by a connector, while the other end of the leash (i.e., distal end to the animal and proximal to the animal handler), which typically has a fixed loop, is either wrapped or tied around the fixed object, or is detached from the animal collar, and wrapped around the fixed object and then inserted through the fixed loop, thereby forming a “slip knot” before being reattached or coupled to the animal collar.

The problem is that there is no way to ensure and to protect the safety of the animal or others during the period of time the leash is detached from the animal's collar. During this period of time, the animal handler may become distracted or have difficulty maintaining control of the animal. The animal may also become distracted, agitated, or excited, which may result in the animal creating a safety concern if the animal darts, pulls, or runs away from the animal handler. Maintaining the safety of the animal, the animal handler, and the public is of paramount importance.

Therefore, there is a need for a system to and method for maintaining the safety and protection of animals, the animal handler, and the public, with animals coupled to a leash.

### SUMMARY

Implementations described and claimed herein address the foregoing problems by providing a leash system, comprising: a lead; a means for attaching the proximal end of the lead to an animal; a handle at the distal end of the lead; a safety tether at the distal end of the lead; and a connector to reversibly couple the proximal and distal ends of the safety tether. Other implementations are also described and recited herein.

### BRIEF DESCRIPTION OF THE FIGURES

FIG. 1 shows a leash coupled to the collar of an animal and an animal handler holding the leash by the handle with the safety tether inactive.

FIG. 2 shows the safety tether wrapped around a fixed object and recoupled, wherein at all times, the animal remains coupled at the collar and the animal handler retains control of the leash by the handle.

FIG. 3 shows the animal secured to a fixed object using the safety tether.

FIGS. 4 and 5 show the safety tether using a release buckle.

FIGS. 6 and 7 show the safety tether using a carabineer with metal rings.

FIGS. 8 and 9 show the safety tether using a stationary or rotating snap hook with metal ring.

FIGS. 10 and 11 depict the safety tether as a fixed but variable length.

FIG. 12 illustrates the safety tether as an elasticized length, shown in the retracted length.

FIG. 13 illustrates the safety tether as an elasticized length, shown in the extended length.

FIG. 14 shows the safety tether as a retractable length, retracted and uncoupled.

FIG. 15 shows the safety tether as a retractable length, extended and coupled.

FIG. 16 shows a leash comprising four loops disposed at various positions on the lead for reversibly coupling the connector of the safety tether. The safety tether is shown coupled to the loop closed to the proximal end of the lead.

FIG. 17 shows a leash comprising four loops disposed at various positions on the lead for reversibly coupling the connector of the safety tether. The safety tether is shown decoupled.

FIG. 18 shows the safety tether functioning as both the leash or lead handle and the safety tether simultaneously.

### DETAILED DESCRIPTION

Disclosed herein is a system for animal care leashes and leads. The safety tether and leash system may include (1) a “safety tether” attached to the animal leash at the distal handle end; (2) a retractable safety tether coil apparatus that is attached to the animal leash or lead at the distal handle end; or (3) a “safety tether leash handle” that has a safety clasp affixed to the handle. The safety tether has a connector that can be uncoupled, wrapped around a fixed object, and connected to a secured metal loop on the leash or tether. Alternatively, the safety leash handle has a buckle or clasp mechanism that uncouples and can be wrapped around a fixed object and then recoupled. The safety tether and the safety leash handle do not require the animal to be unleashed at any time. The safety leash system ensures the safety and protection of animals, the animal handler, and the public.

The tether may be a fixed length, a variable loop, or flexible elastic. In particular, the tether may be (1) a separate piece attached to the leash at the distal handle end, or (2) a continuous length that expands in length after attaching to the leash at the distal end of the handle. The tether may be retractable and self-contained in a plastic or metal hardened container attached to the leash at the distal end of the handle.

The length of tether may be about 8 inches to about 36 inches, such as about 10 inches to about 25 inches, for example about 10 inches, about 15 inches, about 16 inches, about 20 inches, about 25 inches, or about 30 inches. The width of the tether may be about a quarter inch to about 2 inches, such as about half an inch to about an inch and three-quarters, such as about half an inch to about three-quarters of an inch, about three-quarters of an inch to about an inch, about an inch and a quarter, or about an inch and three-quarters. Combinations of lengths and widths of the tether are selected based on the size or the type and breed of the animal, as known to one of skill in the art. Exemplary lengths and widths are depicted in Table 1.

TABLE 1
Sizing chart

| Size | Length (inches) | Width (inches) |
|---|---|---|
| Small | 10 | ½-¾ |
| Medium | 15 | ¾-1 |
| Large | 20 | 1¼ |
| Extra large | 25 | 1¾ |

The “lead” as defined herein is the section of the leash system extending the handle to the means for attaching an animal. The length of lead may be about 3 feet to about 10 feet, such as about 4 feet to about 8 feet, for example about 4 feet, about 5 feet, about 6 feet, about 7 feet, or about 8 feet. In a particular embodiment, the lead is about 6 feet. The width of the lead may be about a quarter inch to about 2 inches, such as about half an inch to about an inch and three-quarters, such as about half an inch to about three-quarters of an inch, about three-quarters of an inch to about an inch, about an inch and a quarter, or about an inch and three-quarters. Combinations of lengths and widths of the lead are selected based on the size or the type and breed of the animal, as known to one of skill in the art. Optionally, the lead may be retractable and self-contained in a plastic or metal hardened container attached to the leash near the distal end of the handle.

The tether, handle, and lead may be made from the same or different materials, including, but not limited to, animal leather, nylon, hemp, cotton, metal, plastic, or other natural or man-made materials. The animal leather may be full thickness or split thickness. Components, such as the tether, handle, and lead may be secured together using any acceptable method known in the art, for example, using a single metal rivet, double metal rivet, single stitching, or double stitching, all with or without adhesive. In some embodiments, the material may be reflective.

The connector for the tether may be distally attached to the safety tether, for example using a crimp connector. A variety of connectors may be selected to reversibly open and close the safety tether, including, but not limited to, a metal ring, center release buckle, reciprocal center buckle, side release buckle, spring hook, stationary snap hook, rotating snap hook, hook-and-loop fastener, S-shaped clasp, snap, or magnet. The hook-and-loop may be, for example, an industrial strength Velcro™ fastener. Likewise, any connector used for the safety tether may also be used for the means for attaching the proximal end of the lead to an animal. Particularly useful is a stationary or rotating snap hook.

In some embodiments, a closed metal ring, such as an O or D ring, may be used. The size of the metal ring may range from about a ½-inch diameter to about a 1½-inch diameter. In other embodiments, the connector may be center or side release buckle component attached either around the leash handle end, or attached between the two pieces of safety tether. In particular, a carabineer or spring hook may be used in conjunction with a pair of metal rings to reversibly open and close the safety tether. In other embodiments, a stationary or rotating snap hook may be used in conjunction with a single metal ring. In exemplary embodiments, the closed metal ring may be used as a fastener for securing a personal item, such as keys, a flashlight, animal waste system, pouch for holding training treats, or the like.

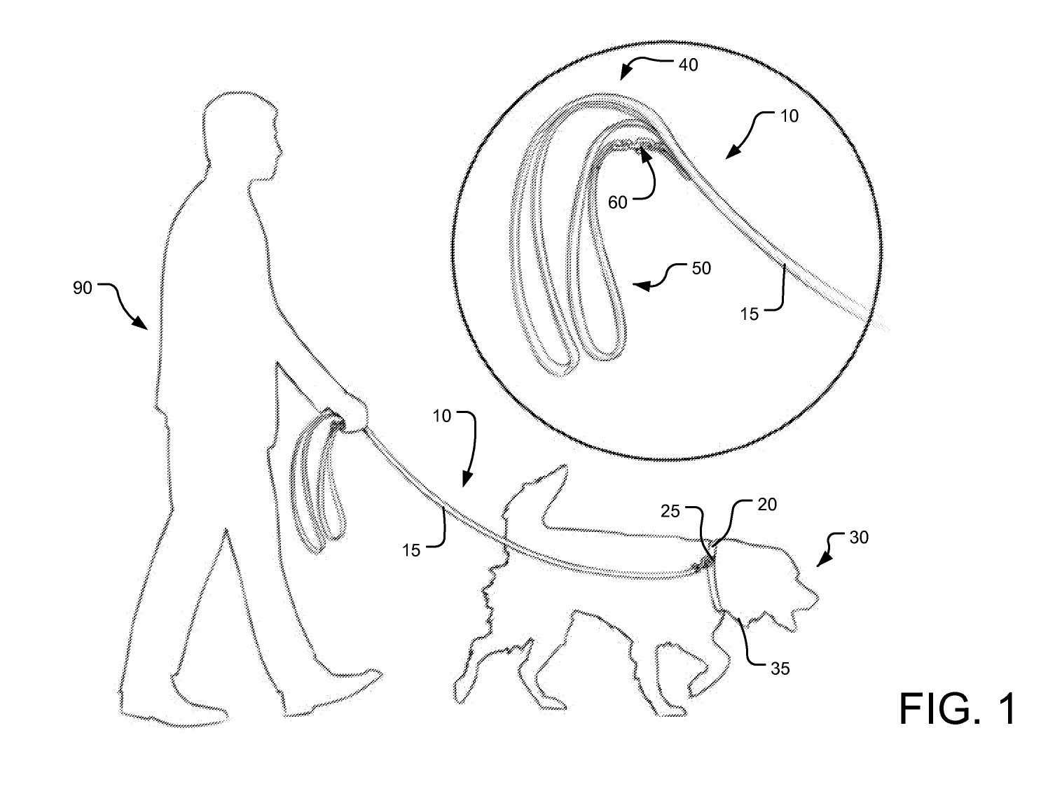

In particular, referring to FIG. 1, a leash 10 is coupled to the collar 20 of an animal 30. The collar is around the animal's neck 35 and is secured. The collar 20 has a metal ring 25 to which the leash 10 is attached. Extended from the collar 20, leash 10 has a variable length lead 15 and width. The animal handler 90 holds the leash 10 the handle 40 with the safety tether 50 inactive.

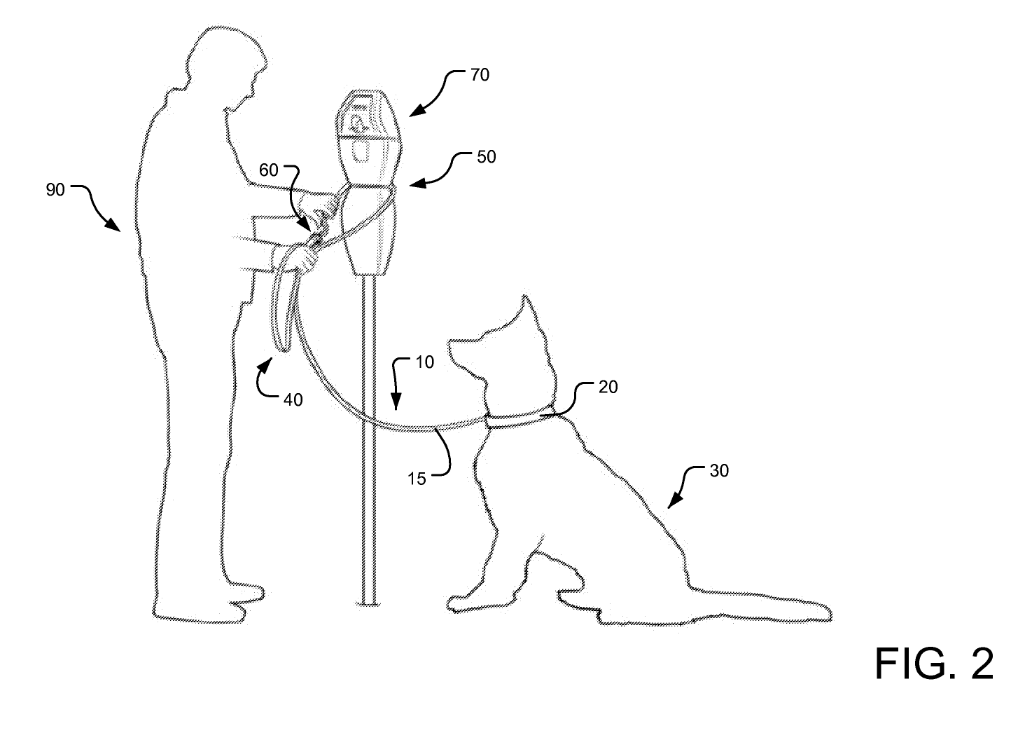

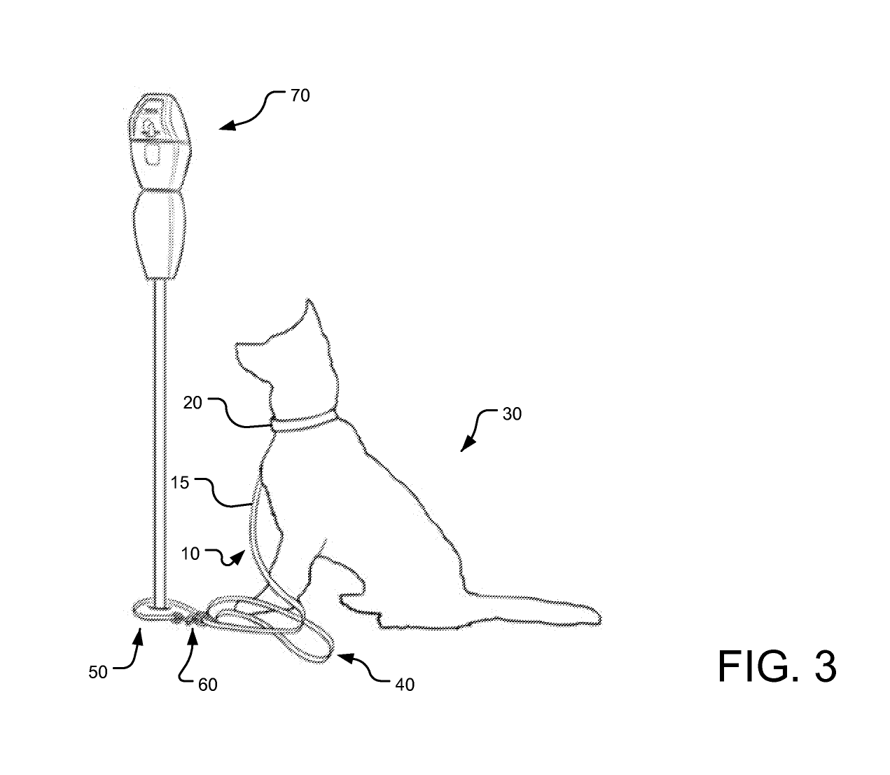

Referring to FIG. 2, when securing the animal 30 to a fixed object 70, the connector of the safety tether 50 is uncoupled. The safety tether 50 is then wrapped around a fixed object 70 and recoupled. At all times, the animal 30 remains coupled at the collar 20 and the animal handler 90 retains control of the leash 10 by the handle 40.

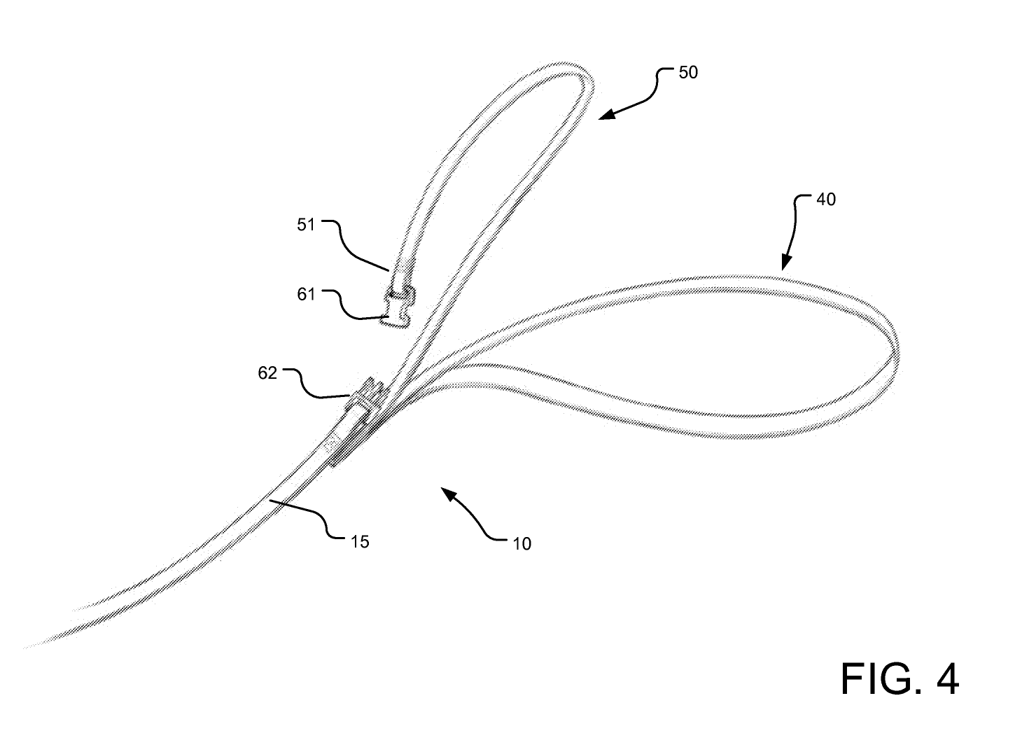

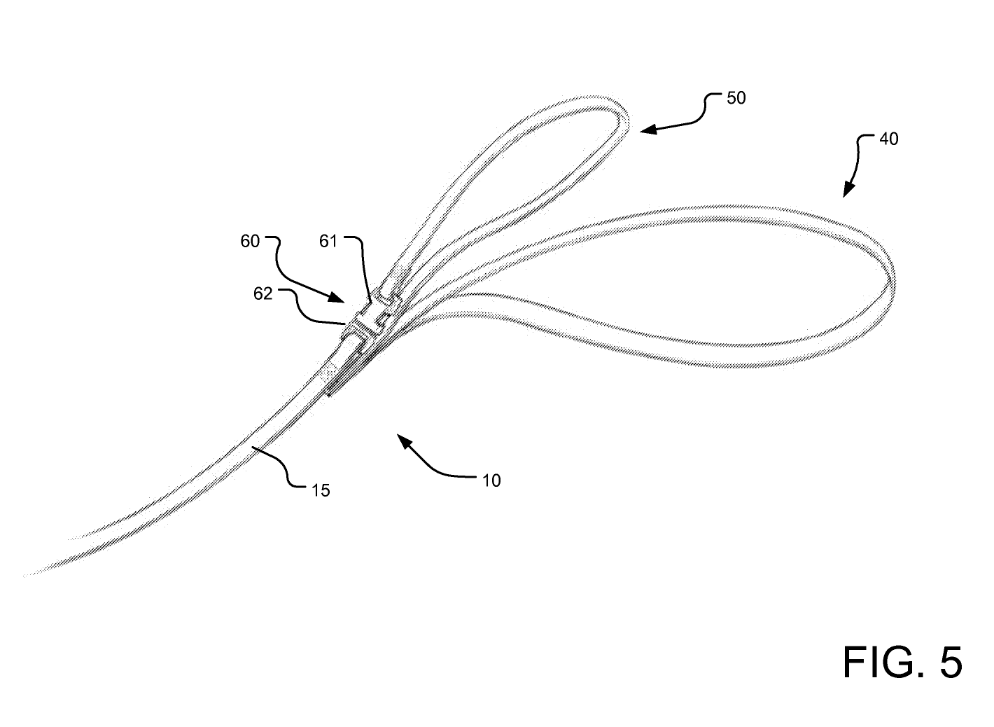

Referring to FIG. 4, the safety tether 50 may use a release buckle 61, 62, opened or uncoupled. When present, the release buckle 61, 62 is affixed to the distal end 51 of the safety tether 50. The buckle 61, 62 permits a quick release or coupling when in use. Referring to FIG. 5, the safety tether 50 using a center or side release buckle 60, closed or coupled.

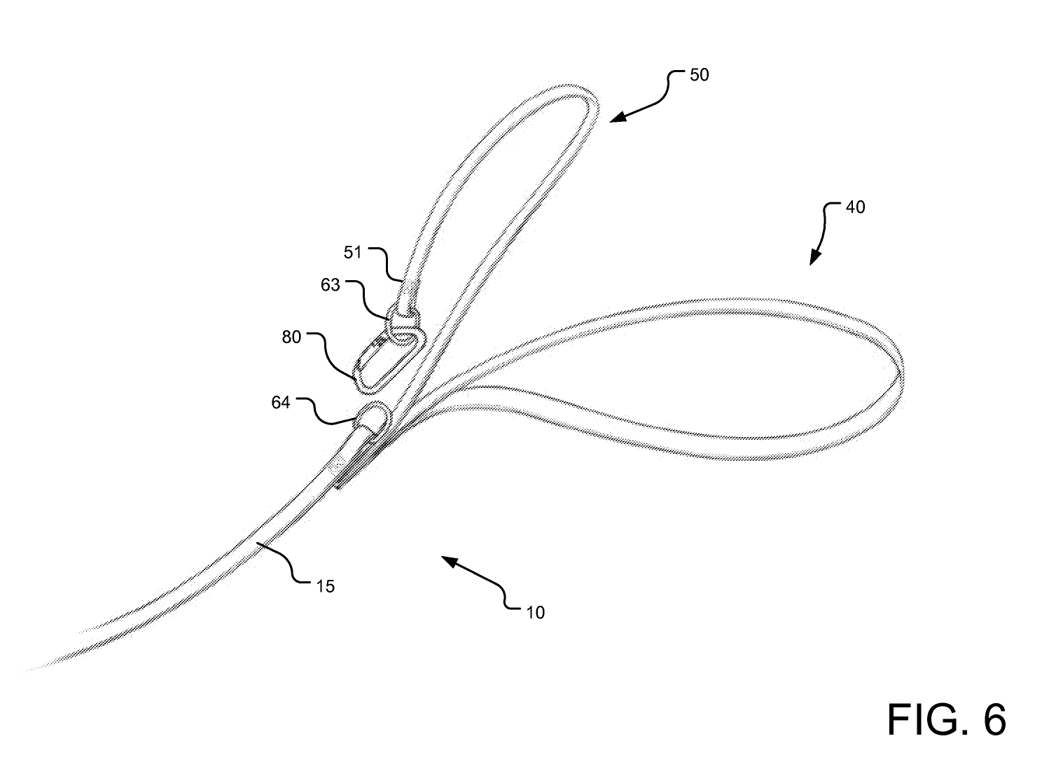

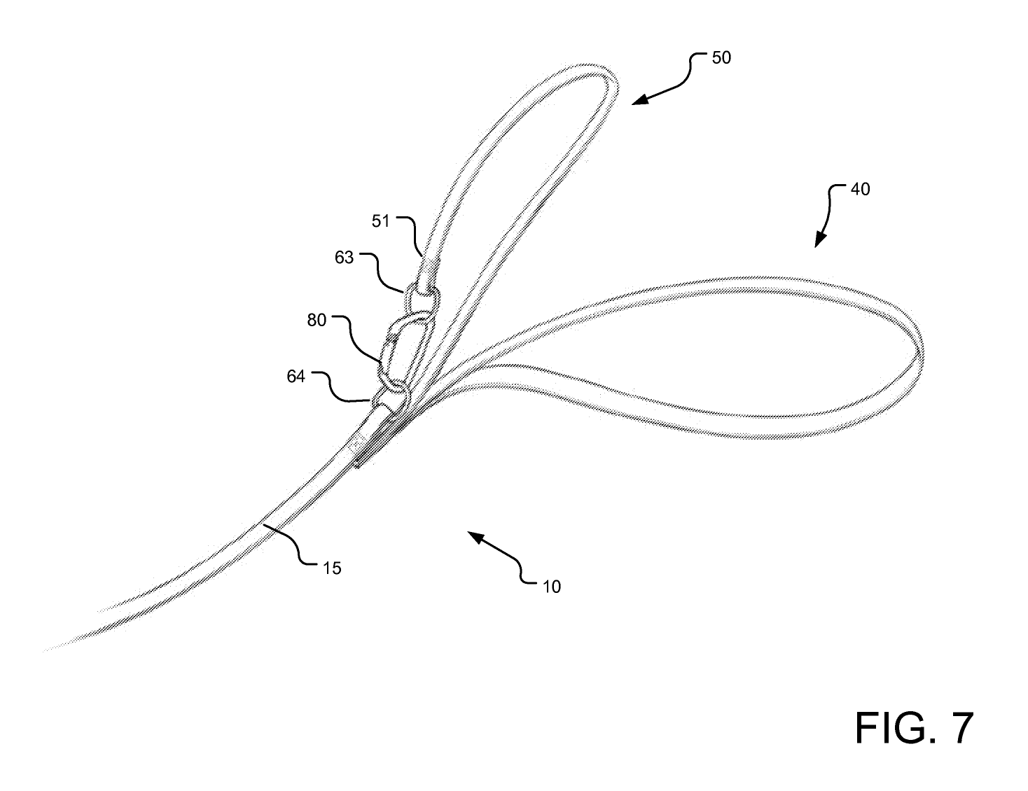

Referring to FIG. 6, the safety tether 50 using a carabineer 80 with metal rings 63, 64, opened or uncoupled. The metal ring 63 is affixed to the distal end 51 of the safety tether 50 opening. The carabineer 80 is affixed to the other end of the opening by a metal ring 64, permitting a quick release or coupling when in use. Referring to FIG. 7, the safety tether 50 using a carabineer 80 coupled with metal rings 63, 64.

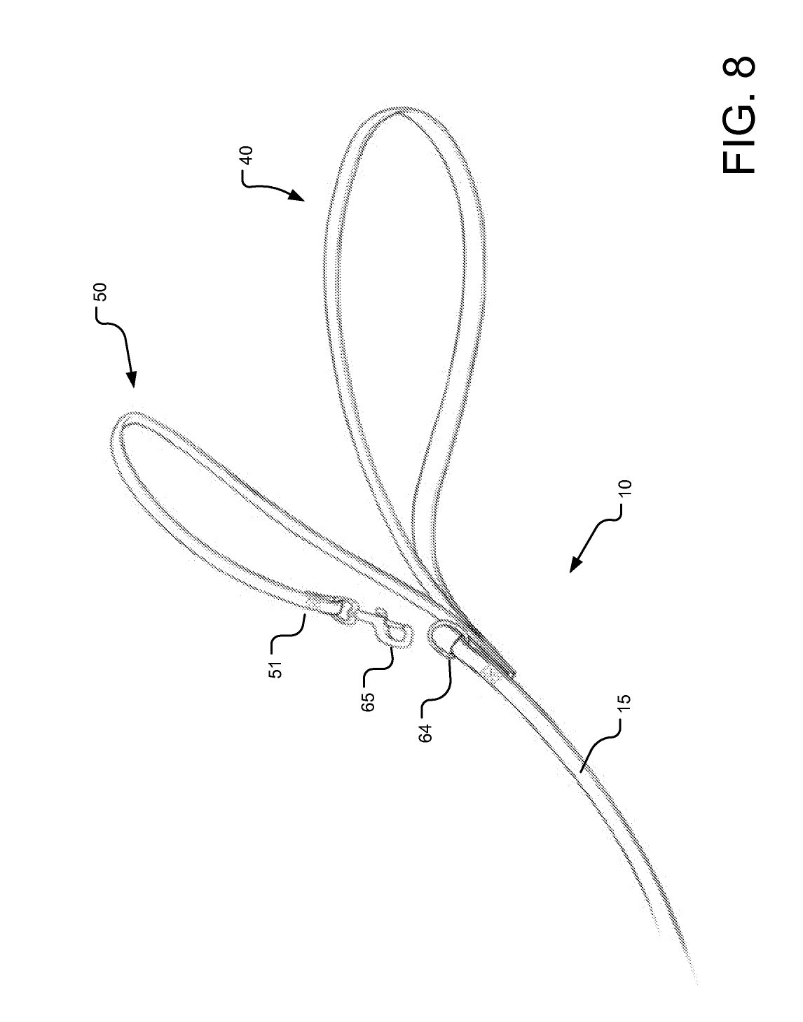

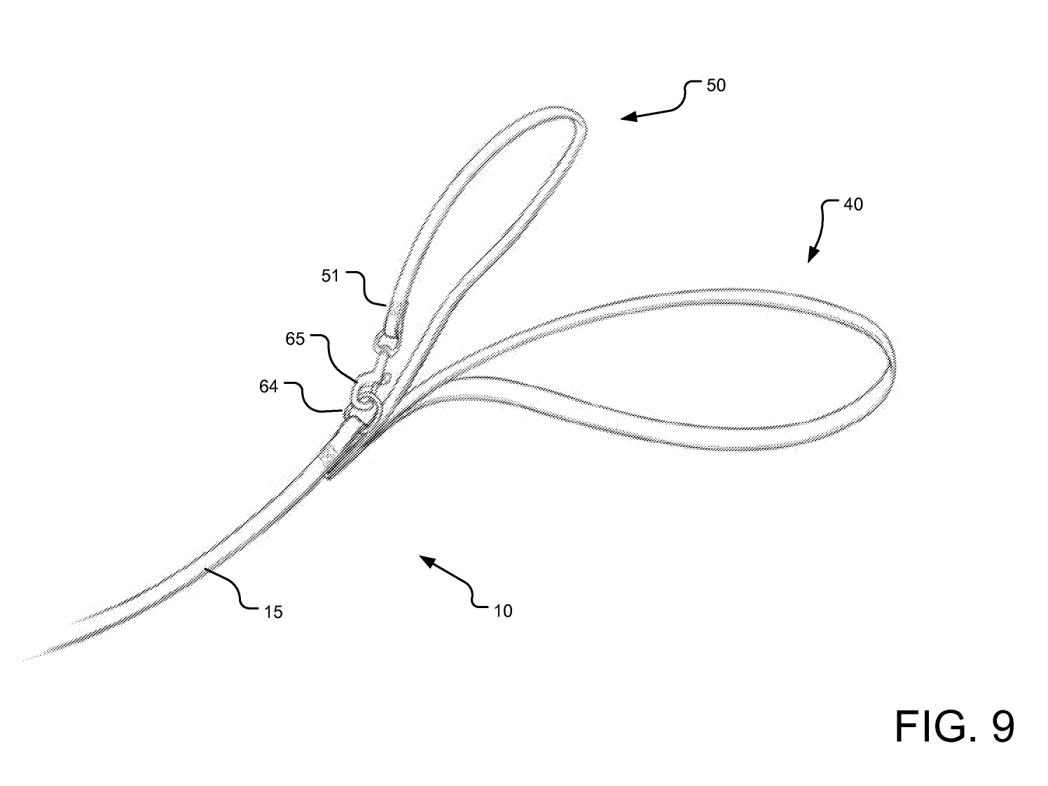

Referring to FIGS. 8 and 9, the safety tether 50 using a stationary or rotating snap hook 65 with a metal ring 64, opened or uncoupled. The metal ring 64 is affixed to one end of the safety tether 50 opening. The snap hook 65 is affixed to the other end of the opening by a metal ring, permitting quick release or coupling when in use.

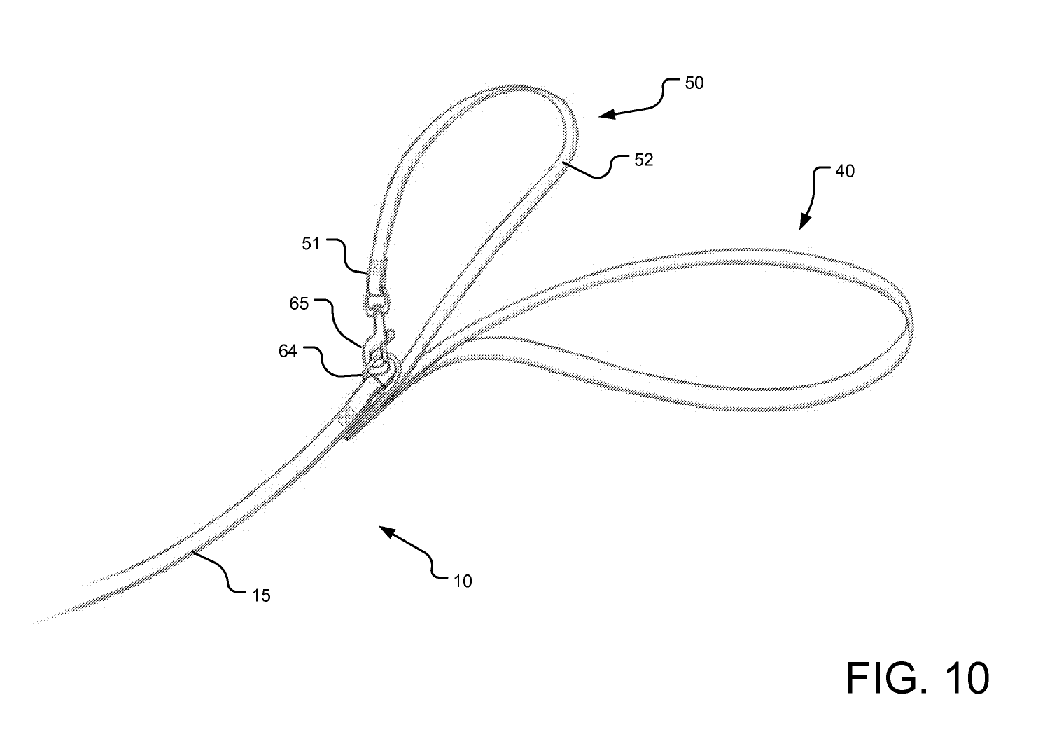

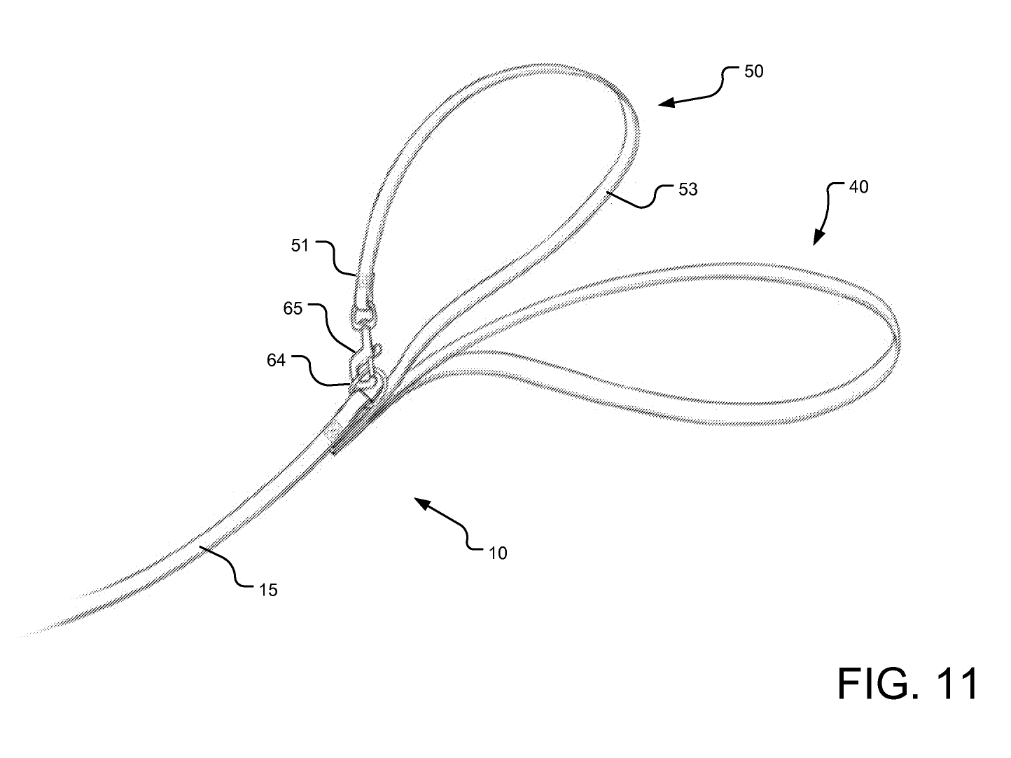

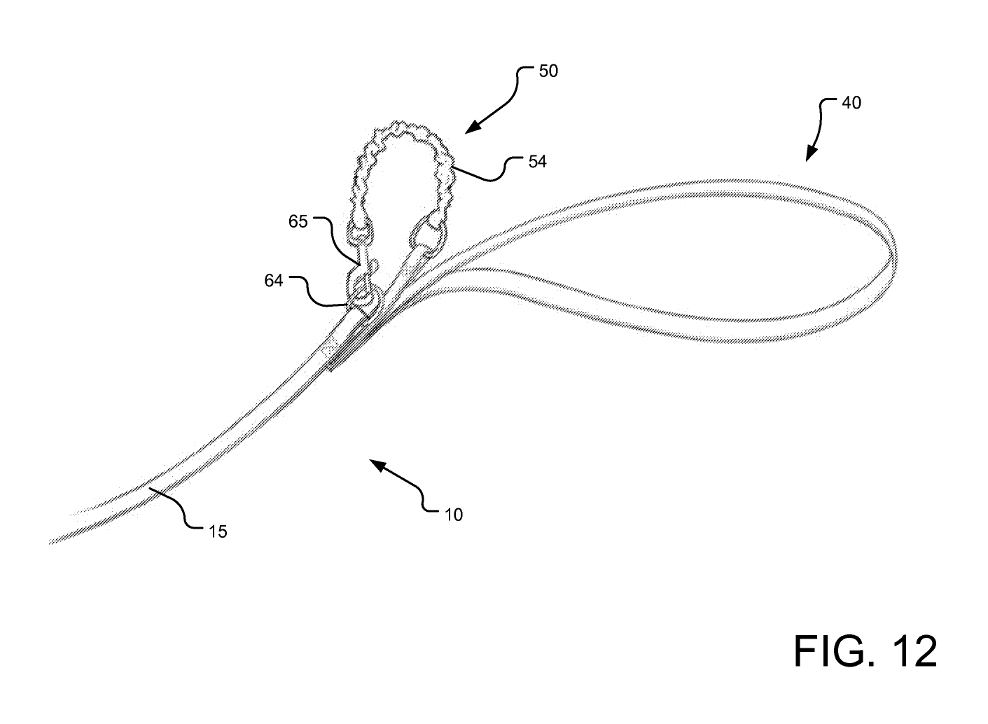

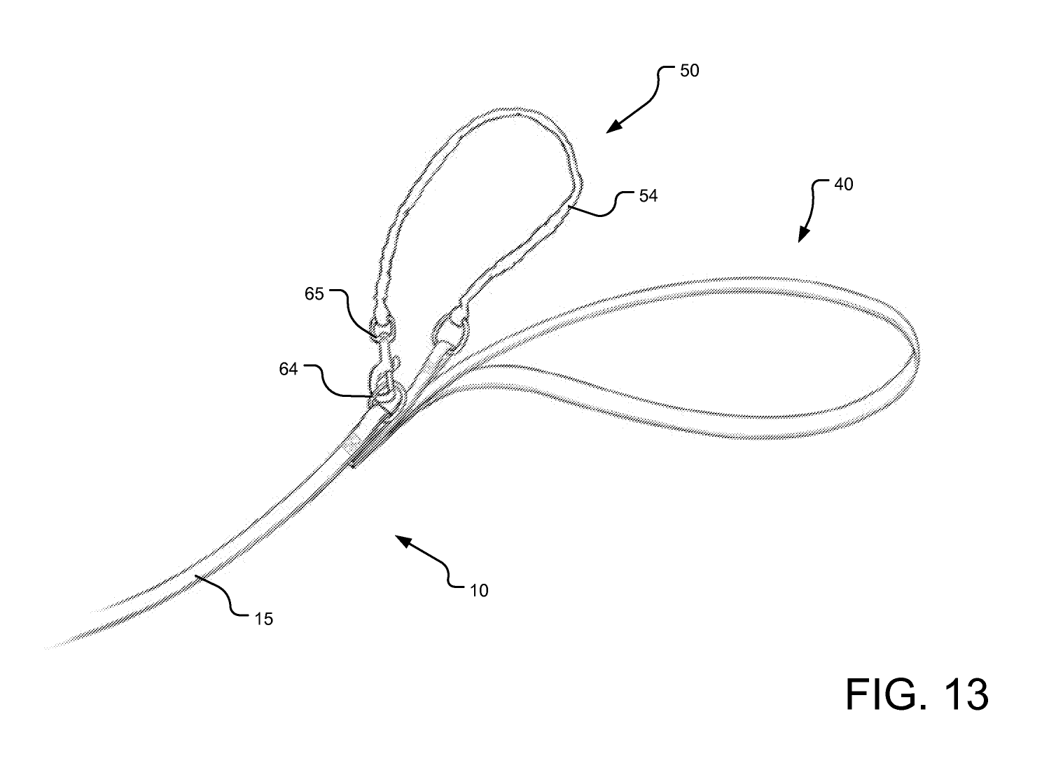

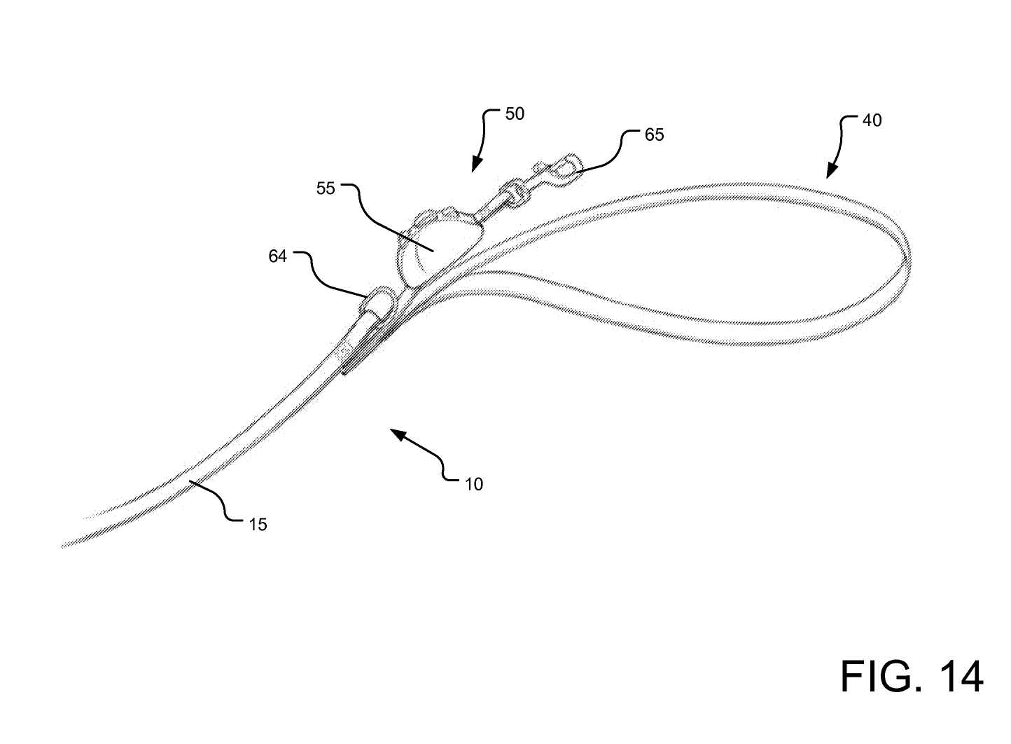

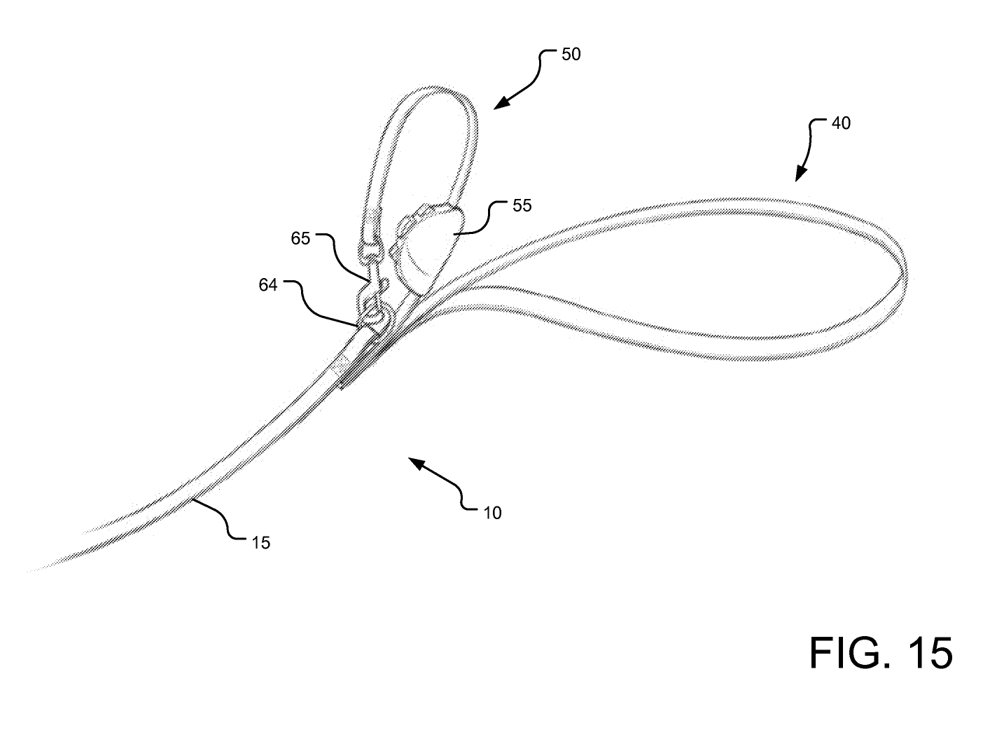

Referring to FIGS. 10 and 11, the safety tether 50 may have a fixed but variable length 52, 53. Referring to FIGS. 12 and 13, the safety tether 50 has an elasticized length 54, which may be retracted or extended. Referring to FIGS. 14 and 15, the safety tether 50 may a retractable length 55, which may be retracted and uncoupled, or extended and coupled.

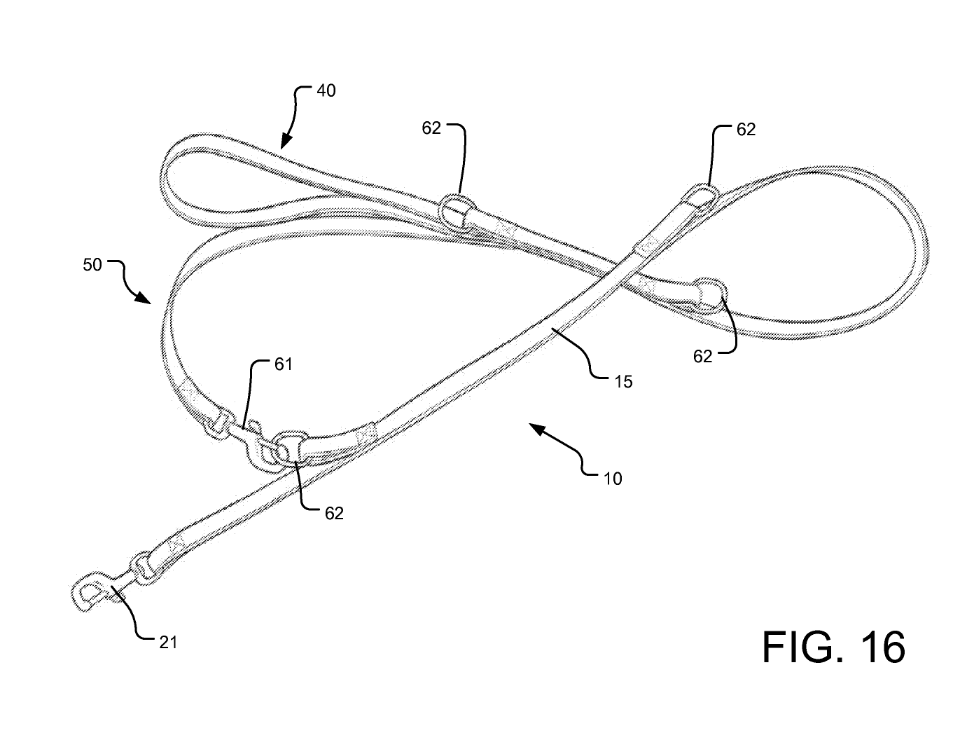

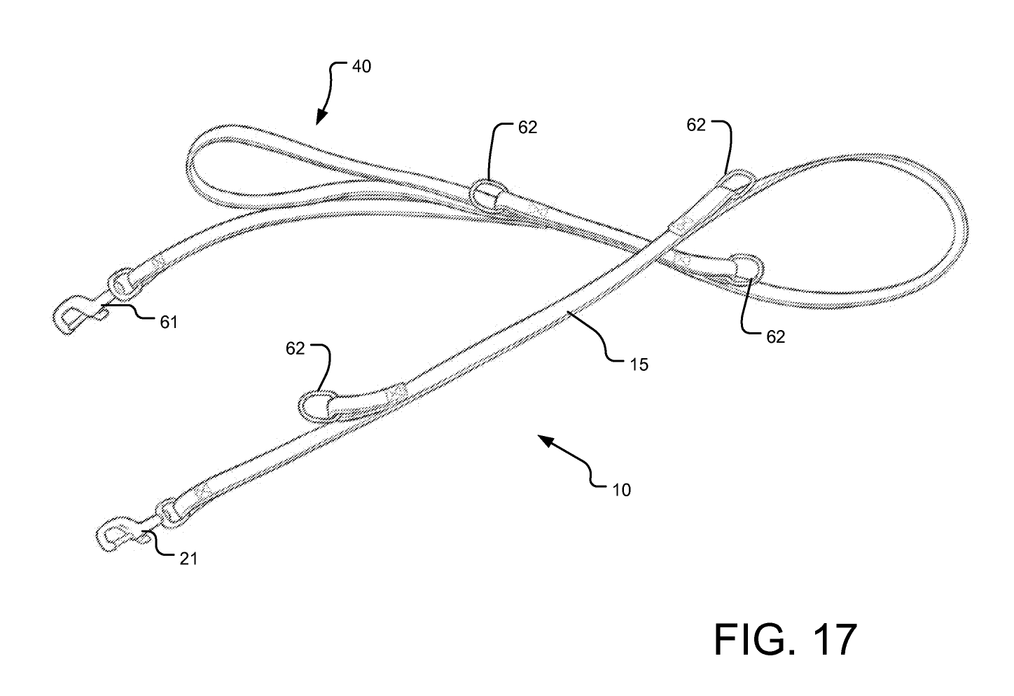

Referring to FIGS. 16 & 17, the leash 10 may comprise a handle 40 and more than one loop 62 to reversibility couple the connector 61 of the safety tether 50. For example, a loop 62 may be located at distal end 51 of the safety tether 50, in the middle of the lead 15, and at the proximal end of the lead 15 near the fastener 21. For example, as depicted at FIGS. 16 & 17, the connector 61 of the safety lead 50 may be coupled to a loop 62 near the proximal end of the lead 15, effectively extending the size of the safety tether to also include a portion of the length of the lead 15. In this way, an animal may be secured to a fixed object having a relatively large diameter, such as the trunk of a tree. In other embodiments, the leash may be used as a hands-free leash by looping the extended safety tether around the body of the animal handler. In other embodiments, the leash 10 may comprise at least two loops 62, for example, at least three loops, or at least four loops, disposed a various positions on the lead 15.

The leash 10 may further comprise a pass-through loop, through which the lead 15 may be looped to form a secondary loop. In some embodiments, the secondary loop may function as a handle while using the leash as a traffic leash. In other embodiments, the leash may be used as a double leash, wherein the secondary loop functions as a handle, a first animal is coupled to connector 21, and a second animal is coupled to connector 61.

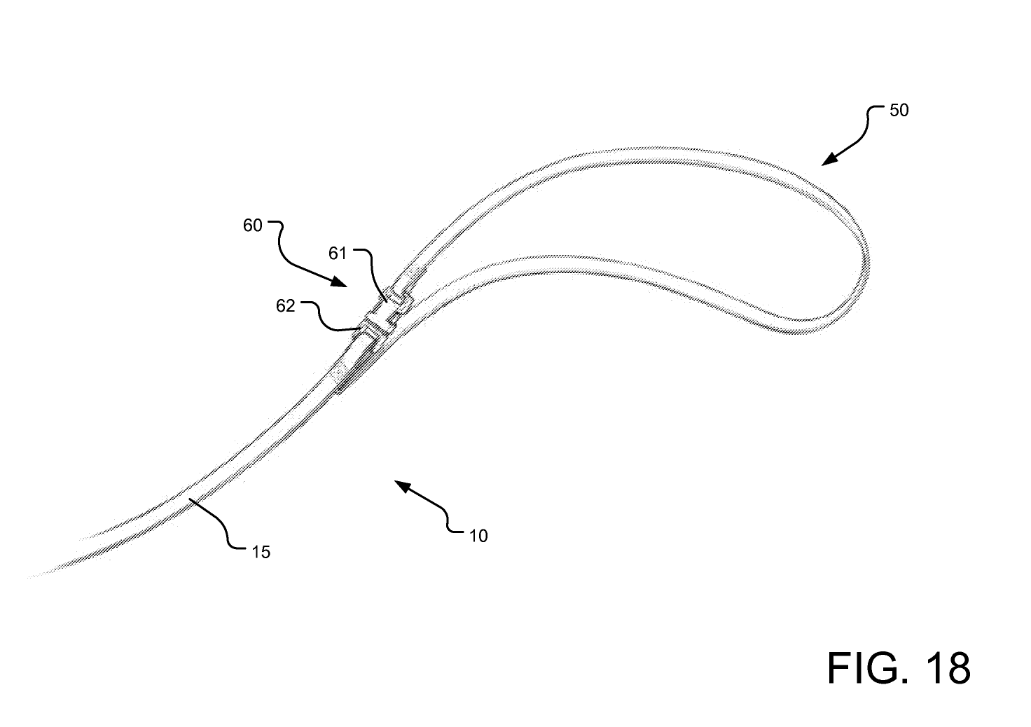

Referring to FIG. 18, the safety tether 50 may function as the handle 40 and the safety tether 50 simultaneously. The safety tether may be coupled with any suitable connector 60, such as a center release buckle, side release buckle, metal ring with spring clip or carabineer, or ring with stationary or rotating snap hook. The safety tether may be a fixed length, elasticized, or retractable length. In some embodiments, the leash may comprise two or more loops disposed at different positions on the lead for reversibly coupling the connector of the safety tether. In other embodiments, the leash may comprise a pass-through loop in the lead.

The above specification, examples, and data provide a complete description of the structure and use of exemplary embodiments of the disclosure. Since many embodiments of the disclosure can be made without departing from the spirit and scope of the disclosure, the disclosure resides in the claims hereinafter appended. Furthermore, structural features of the different embodiments may be combined in yet another embodiment without departing from the recited claims.

What is claimed is:

1. A leash system for attachment to an animal, comprising:
a lead;
an attachment mechanism adapted to attach the proximal end of the lead to the animal;
a safety tether at the distal end of the lead; and
a connector to reversibly couple the distal end of the safety tether to the leash system.

2. The leash system of claim 1, further comprising a handle at the distal end of the lead.

3. The leash system of claim 1, wherein the lead further comprises at least one loop to reversibly couple the connector.

4. The leash system of claim 3, wherein the lead comprises at least two loops disposed at different positions on the lead.

5. The, leash system of claim 1, wherein the tether is a fixed length, a variable loop, or elasticized.

6. (canceled)

7. The leash system of claim 1, wherein the connector is selected from the group consisting of a metal ring, center release buckle, reciprocal center buckle, side release buckle, carabineer, spring hook, stationary snap hook, rotating snap hook, hook-and-loop fastener, S-shaped clasp, snap, and magnet.

8. The leash system of claim 7, wherein the connector is a metal ring selected from an O ring or a D ring.

9. The leash system of claim 1, further comprising a metal ring that functions as a fastener for securing a personal item.

10. The leash system of claim 7, wherein the connecter consists of a carabineer or spring hook used in combination with two metal rings.

11. The leash system of claim 7, wherein the connector consists of a metal ring, used in combination with a stationary or rotating snap hook.

12-17. (canceled)

18. The leash system of claim 1, wherein the safety tether functions as both a tether and a handle.

19-22. (canceled)

23. A leash system for attachment to an animal, comprising:
a lead;
an attachment mechanism adapted to attach the proximal end of the lead to the animal;
a handle at the distal end of the lead;
a safety tether at the distal end of the lead; and
a connector to reversibly couple the proximal and distal ends of the safety tether.

24. The leash system of claim 23, wherein the tether is a fixed length, a variable loop, or elasticized.

25. (canceled)

26. The leash system of claim 23, wherein the connector is selected from the group consisting of a metal ring, center release buckle, reciprocal center buckle, side release buckle, carabineer, spring hook, stationary snap hook, rotating snap hook, hook-and-loop fastener, S-shaped clasp, snap, and magnet.

27. The leash system of claim 26, wherein the connector is a metal ring selected from an O ring or a D ring.

28. The leash system of claim 23, wherein the further comprising a metal ring that functions as a fastener for securing a personal item.

29. The leash system of claim 26, wherein the connecter consists essentially of a carabineer or spring hook, used in combination with two metal rings.

30. The leash system of claim 26, wherein the connector consists of a metal ring, used in combination with a stationary or rotating snap hook.

31-36. (canceled)

37. The leash system of claim 1, wherein the safety tether functions as both a tether and a handle.

38-40. (canceled)

41. The leash system of claim 23, wherein the lead further comprises at least two loops disposed at different positions on the lead for reversibly coupling the connector.

42. (canceled)

43. The leash system of claim 1, wherein the attachment mechanism is selected from the group consisting of a metal ring, center release buckle, reciprocal center buckle, side release buckle, carabineer, spring hook, stationary snap hook, rotating snap hook, hook-and-loop fastener, S-shaped clasp, snap, and magnet.

44. The leash system of claim 23, wherein the attachment mechanism is selected from the group consisting of a metal ring, center release buckle, reciprocal center buckle, side release buckle, carabineer, spring hook, stationary snap hook, rotating snap hook, hook-and-loop fastener, S-shaped clasp, snap, and magnet.
